(19) United States
(12) Patent Application Publication
(10) Pub. No.: US 2022/0048255 A1
(43) Pub. Date: Feb. 17, 2022

(54) METHOD AND APPARATUS FOR PARALLELIZED ADDITIVE MANUFACTURING

(71) Applicant: The Government of the United States of America, as represented by the Secretary of the Navy, Arlington, VA (US)

(72) Inventors: Athanasios Iliopoulos, Bethesda, MD (US); John G. Michopoulos, Washington, DC (US); John C. Steuben, Washington, DC (US); Benjamin D. Graber, College Park, MD (US); Andrew J. Birnbaum, Washington, DC (US)

(21) Appl. No.: 17/403,798

(22) Filed: Aug. 16, 2021

Related U.S. Application Data
(60) Provisional application No. 63/065,877, filed on Aug. 14, 2020.

(51) Int. Cl. B29C 64/393; B33Y 10/00; B33Y 30/00; B33Y 50/02; B29C 64/153; B29C 64/268; B29C 64/282; B29C 64/236; B22F 10/28; B22F 10/85; B22F 12/00; B22F 12/41; B22F 12/45; B22F 12/47

(52) U.S. Cl. CPC B29C 64/393; B33Y 10/00; B33Y 30/00; B33Y 50/02; B29C 64/153; B29C 64/268; B22F 12/47; B29C 64/236; B22F 10/28; B22F 10/85; B22F 12/224; B22F 12/41; B22F 12/45; B29C 64/282

(57) ABSTRACT

An additive manufacturing device includes a container bed configured to contain material powder; a printing bed over which material is deposited and heat applied; one or more heating elements configured to hold material on the printing bed and material on the container bed at temperatures higher than ambient; one or more actuators; and a two-dimensional array of heat deposition devices configured for a 2D space filling movement by the one or more actuators in a plane generally perpendicular to an optical axis of the heat deposition devices.

### RELATED APPLICATIONS

This application claims the benefit of U.S. Provisional Application No. 63/065,877 filed Aug. 14, 2021, which is hereby incorporated herein by reference.

### FEDERALLY-SPONSORED RESEARCH AND DEVELOPMENT

The United States Government has ownership rights in this invention. Licensing inquiries may be directed to Office of Technology Transfer, US Naval Research Laboratory, Code 1004, Washington, D.C. 20375, USA; +1.202.767.7230; techtran@nrl.navy.mil, referencing NC 113518.

### FIELD OF INVENTION

The present invention relates generally to additive manufacturing, and more particularly to parallelized additive manufacturing using an array of heating elements.

### BACKGROUND

While a wide array of additive manufacturing processes have been developed, the dominant techniques include those that are deposition-based, such as Fused Deposition Modeling (FDM), photo-activation-based, such as stereolithography and thermal melting/sintering-based, such as Selective Laser Sintering (SLS). All of these techniques rely on the use of a point-by-point paradigm for realizing physical objects from virtual models.

FDM typically relies on the use of polymer filaments extruded through a heated orifice for softening the material above its glass-transition temperature, and deposition on a platform using a Cartesian mechatronic motion system to realize the path/layer geometry. Upon layer deposition, the material cools, fully hardens and solidifies, and adheres to the platform (in the case of the first layer) or preceding layer already deposited. Although there have been some efforts at using metal wire filaments to generate metal objects, the temperature requirements for melting (significantly higher than polymers) and atmospheric control to avoid deleterious oxidation have resulted in a reduced use for most commercial and consumer applications. Spatial resolution [planar] for this process is typically on the order of 200 um. Due to the limitations of polymer materials, the mechanical performance for most FDM-produced components is not sufficient for application in mechanically demanding environments.

Stereolithography uses lasers to photopolymerize and harden initially liquid, photocurable resins in order to build three-dimensional objects, again through a layer-by-layer approach. A major advantage of stereolithography is that its resolution is far greater than FDM as it is fundamentally limited by the laser spot size and thermo-viscosity of the liquid, allowing the creation of much finer features with greater fidelity. The drawback, however, is the material systems that can be used are extremely limited, and do not exhibit suitable mechanical performance for most structural applications. However, there have been recent efforts using pre-ceramic based polymers that are photo-activated resulting in ceramic parts that have superior properties to those manufactured using common photopolymers.

SLS processes are based upon using lasers to locally melt or sinter polymer or metal powder precursors in order to create cross-sections for layer-wise three dimensional object creation. Its ability to create metallic components has facilitated its adoption across a much wider range of industries and applications. It exhibits the fine spatial resolution enabled by its use of a laser source, while also maintaining its ability to produce components with far greater mechanical performance than stereolithography due to its ability to process a wider range of material systems. However, as the melting or sintering process occurs relatively rapidly, the resulting components created tend to exhibit many types of micro and macro scale flaws including significant degrees of porosity, microstructural defects, cracks and warpage. These flaws result in components whose performance is significantly degraded relative to their fully dense counterparts. Post-processing steps are also frequently required before objects can be employed in a functional manner. A related technique, known as Electron Beam Melting (EBM) functions in a virtually identical manner to SLS, except for the use of an electron-beam energy source instead of a laser.

It is also noted that while the common techniques described above adhere to an ultra-serialized approach, a point by point building of an object, there have been efforts at generating objects in a truly layer-by-layer fashion. The so-called printing process employs the time varying projection of a two-dimensional image on a continuous, vertically translating build platform to photo-polymerize cross-sectional layers for subsequent object creation. Another technique for creating objects through true section-wise construction is the so-called laser decal transfer process which utilizes high viscosity “nano-inks” that can preserve the geometry of the laser beam used to propel a portion of material on to a substrate for building objects, typically at micron to millimeter scales.

### SUMMARY OF INVENTION

Disclosed herein is a method for the automated, parallelized and therefore accelerated manufacturing of three-dimensional objects. This is accomplished by the application of heat generated via an array of directed energy devices positioned on top of a bed containing powdered precursor material. The heat melts the powder particles and the resulting liquid consolidates. Upon cooling the melt solidifies and forms a locally shaped material. Since all elements of the array cannot move independently to each other, their support frame has to move in a manner that forces each element to follow a space filling trajectory for a sub-domain of the surface so that all sub-domains tile that surface that contains the convex hull of the part under manufacturing. Consequently, to selectively melt and solidify the powder at desired locations, the apparatus controls the timing of the energy release to achieve solidified shaping control for each individual element of the array. By successively introducing new layers of powder via a recoating sub-system the method provides the means for the manufacturing of three dimensional objects in a parallelized additive manner.

According to one aspect of the invention, an additive manufacturing device includes a container bed configured to contain material powder; a printing bed over which material is deposited and heat applied; one or more heating elements configured to hold material on the printing bed and material on the container bed at temperatures higher than ambient; one or more actuators; and a two-dimensional array of heat deposition devices configured for movement by the one or more actuators in a plane generally perpendicular to a beaming axis of the heat deposition devices.

Optionally, the additive manufacturing device includes a re-coater blade configured to actuate so as to transfer powder from the container bed to the printing bed.

Optionally, the powder container is configured to actuate in the vertical direction an amount correlated to a desired thickness of a powder layer to be transferred to the printing bed.

Optionally, the printing bed is configured to actuate in the vertical direction, after each layer has been built, making room for a new layer of material powder.

Optionally, the one or more actuators include a first actuator configured to move the array in a first direction perpendicular to the beaming axis and a second actuator configured to move the array in a second direction, the second direction being perpendicular to the beaming axis and perpendicular to the first direction, and wherein the two-dimensional array of heat deposition devices is configured for movement in the first and second directions simultaneously.

Optionally, the additive manufacturing device includes a processor, the processor configured to perform the steps of: receiving a desired 2D heat deposition pattern; calculating, based on the received pattern and a known 2-dimensional array of heat deposition elements, a space filling curve for an area under the array of heat deposition devices; generating actuation instructions based on the space filling curve; moving the array of heat depositions devices based on the actuation instructions, thereby following the space filling curve; generating switching instructions, based on the received pattern and the space filling curve, for the heat deposition devices; and selectively powering the heat deposition devices while the array is moving, based on the switching instructions, thereby depositing energy that matches the desired 2D heat deposition pattern when the array follows the space filling curve.

According to another aspect of the invention, a method of additive manufacturing includes coating a printing bed by moving a re-coater plate through material in a powder container; moving the powder container vertically upwards for each layer; moving the printing bed vertically downwards for each layer; moving a two-dimensional array of heat deposition devices horizontally within predefined limits; selectively switching on and off the heat deposition devices during movement of the two-dimensional array; and providing power to heating elements configured to heat material on the printing bed and the powder container.

Optionally, the steps of the method are selectively completed based on an object to be printed by the method.

According to another aspect of the invention, a method of additive manufacturing includes receiving a desired 2D heat deposition pattern; calculating, based on the received pattern and a known 2-dimensional array of heat deposition devices, a space filling curve for an area under the array of heat deposition devices; generating actuation instructions based on the space filling curve; moving the array of heat deposition devices based on the actuation instructions, thereby following the space filling curve; generating switching instructions, based on the received pattern and the space filling curve, for the heat deposition devices; and selectively powering the heat deposition devices while the array is moving, based on the switching instructions, thereby depositing energy that matches the desired 2D heat deposition pattern when the array follows the space filling curve.

Optionally, the method includes the steps of receiving a 3D geometry; slicing the 3D geometry into a series of stacked 2D heat deposition patterns collectively approximating the 3D geometry; and iteratively performing the steps of receiving, calculating, generating actuation instructions, moving, generating switching instructions, and selectively powering the heat deposition devices for each heat deposition pattern.

The foregoing and other features of the invention are hereinafter described in greater detail with reference to the accompanying drawings.

### BRIEF DESCRIPTION OF THE DRAWINGS

FIG. 1 shows a schematic of an exemplary additive manufacturing device.

FIG. 2 shows example 2D paths of a heat deposition array.

FIG. 3 shows an exemplary additive manufacturing device in use.

FIG. 4 shows an exemplary additive manufacturing device in use.

FIG. 5 shows an exemplary additive manufacturing device in use.

FIG. 6 shows an exemplary additive manufacturing device in use.

FIG. 7 shows an illustration of a mode of operation of an exemplary device.

FIG. 8 shows an exemplary method of additive manufacturing.

### DETAILED DESCRIPTION

Exemplary embodiments of the present invention include both a method and an apparatus for creating three-dimensional objects based upon virtual representations in a parallelized and efficient additive manner. The proposed method, unlike conventional approaches, uses an array of energy deposition devices (such as laser diodes), to process multiple locations simultaneously in a parallel fashion. This is in contrast to the point-by-point methods dictated by the vast majority of existing techniques.

The main challenge in enabling the manufacture of desired shapes using an array of heat deposition devices is that they are mounted some fixed distance apart relative to each other, thus inhibiting their individual control in the classical point-by-point manner.

Exemplary embodiments of the invention disclosed herein address this challenge via the implementation of two distinct features that reverse the control role from that of the position to that of the activation time and duration. The first feature is that a space-filling pattern that is common to all of the independent energy deposition devices is programmed in the position control. The second feature is that given that all elements follow the same space-filling trajectory in a manner that tiles the entire surface, the desired build shape is then achieved by controlling the time of turning on and the duration of each individual energy deposition device.

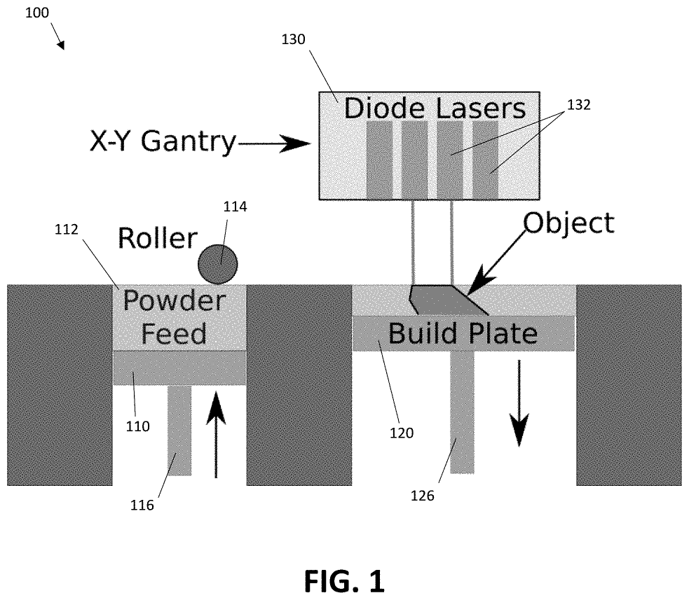

Referring first to FIG. 1 a simplified side view of an exemplary additive manufacturing device 100 is shown. A container bed 110 contains material powder 112 that a re-coater blade or roller 114 is used to transfer to the printing bed or build plate 120. Both the container bed 110 and the printing bed 120 can be actuated (by actuators 116 and 126, respectively) vertically to keep the powdered material at the appropriate height for use in manufacturing. Heating elements (not shown) are configured to hold material on the printing bed and material on the container bed at temperatures higher than ambient. Finally, a two-dimensional array 130 of heat deposition devices 132 are configured for movement by the one or more actuators (not shown) in a plane generally perpendicular to a beaming axis of the heat deposition devices. An exemplary embodiment of the heat deposition source array can be an array of laser diodes, for example.

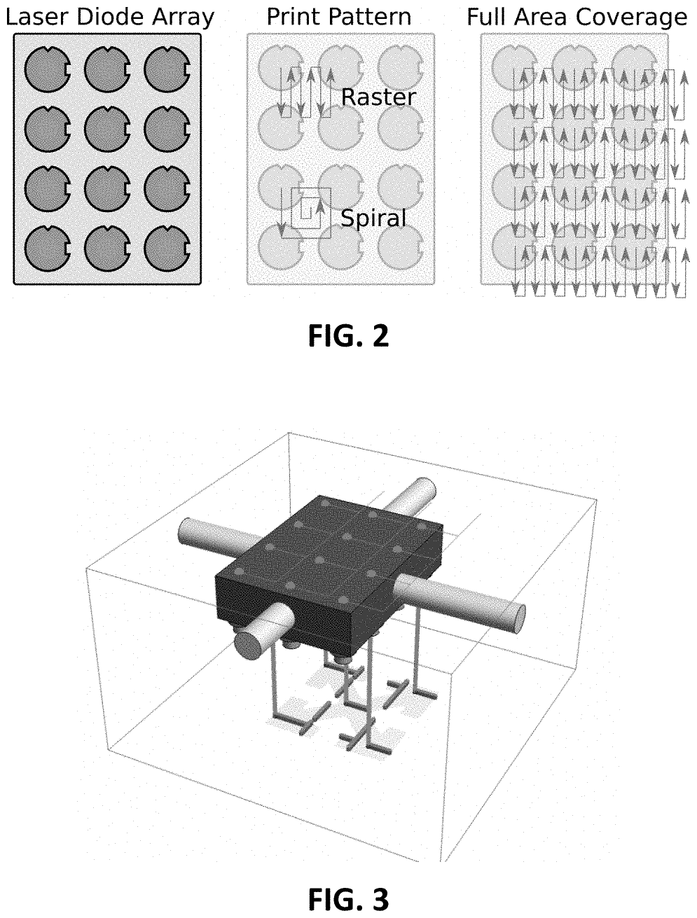

A main concept of an exemplary method is demonstrated in FIG. 2 for two examples of space-filling curve: a raster and a spiral. A 3×4 array 130 of laser diodes 132 arranged in a rectangular manner is considered here. The array is attached to a planar motion platform that can move both vertically and horizontally with 3 degrees of freedom. A path geometry can then be uniformly instituted over all devices by controlling the position of the planar platform supporting the heat deposition elements. If each of the laser diodes is active, then the laser beam will deposit heat on the incident surface in a manner that can rapidly cover the entire area, as shown on the right image of FIG. 2. In order to control the shape of the heat activated areas, we can then temporally control the on/off state of each heat deposition element (e.g., a laser diode) and induce melting at the desired shape. The method described here can be used for arrays with any number of elements (diodes), set in any unique geometry, and scales to any size for coverage of large areas. Additionally, the space-filling curve can be any useful pattern, so long as the full area of the desired shape is covered. As the surface area increases, so too can the number of elements, keeping manufacturing time per layer approximately equal, regardless of size.

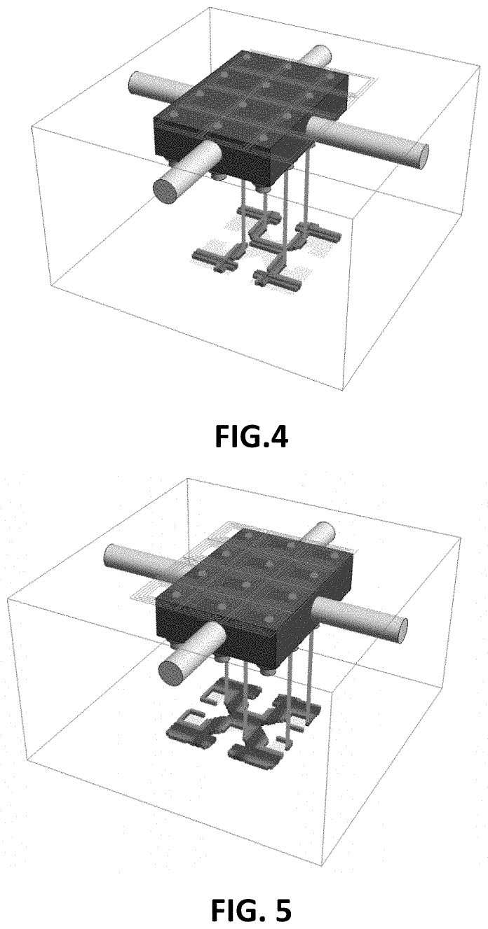

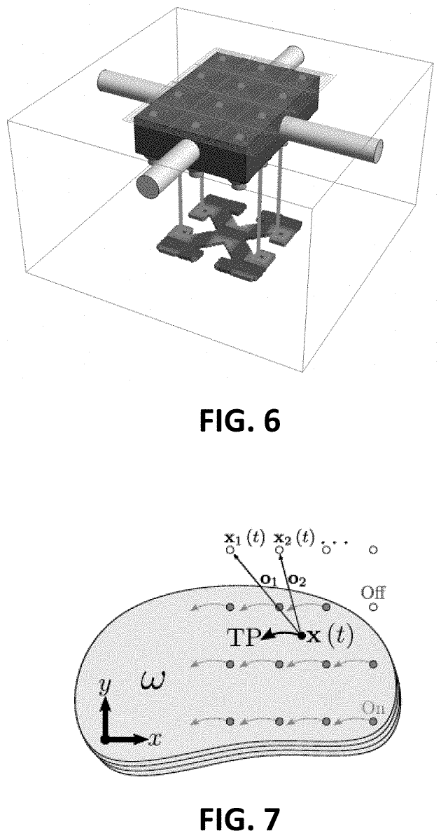

A demonstration of the motion and selective laser activation is presented in the four sequential frames depicted in FIGS. 3-6. The desired shape is shown as a faint grey-filled area in FIG. 3. In the same figure an already melted curve is shown, together with the activate laser beams of the current time point. As the motion platform translates, the shape is being scanned on the surface of the material platform (e.g., powder bed), while the lasers activate appropriately to induce local heating. The rest of the figures show other stages of the process with FIG. 6 showing a frame a short time before the end of the scanning process. The brightness of the grey shades on the shape indicate approximate thermal history.

In exemplary embodiments, the array follows a pattern dictated by a 2D space-filling curve, which may be arbitrarily specified, and which is not a strong function of the desired output geometry (as is the case for conventional AM methods). This pattern may assume any form, and different patterns may optionally be used for different layers as long as it fills the sub-domain space associated with each individual array element. Non-exhaustive examples of 2D-space filling curves include a square helicoidal or a boustrophedonic one. Because the array is moving according to an externally specified pattern, the main process planning task is reduced to determining the temporal sequence of activation and deactivation for each element in the array. This exercise is termed “source sequencing.”

The source array is assumed to be rigid and geometrically invariant as a function of time from the perspective of the positioning of each element relative to each other. The reference position on the array is denoted x(t), where t denotes time. The position of the i^{th} element of the heat source array is defined xᵢ(t)=x(t)+oᵢ, where oᵢ is the offset vector. An activation state function f dictates the state of each elemental source based on their location. A simple example, used to generate proof-of-concept results is based on region membership, i.e.

$$f ( {x}_{i} ) = \{ \begin{matrix}1 & {x}_{i} ∈ ω \\ 0 & {x}_{i} ∉ ω\end{matrix} \qquad ( 1 )$$

where ω corresponds to the desired output geometry. FIG. 7 illustrates this concept graphically. As the reference location x moves along the predetermined space-filling toolpath (TP), its motion is replicated by each of the array elements due to the invariance of the position of each element relative to each other as enforced by the rigid nature of their support base, the kinematics of which apply this space-filling path. These elements are switched to an “On” state if they are within w, otherwise they are switched to an inactive “Off” state. It is important to note that f need not return a binary on/off value. Different functions could be used to smoothly vary source power profiles to achieve effects on the output object's surface finish or other properties. Additionally, the array offsets need not correspond to a regular grid. The formulation employed allows for an arbitrary number and arrangement of array elements.

An array of laser diodes may be attached to a translation stage that's motion is controlled by stepper motors. The laser diodes may be mounted on a frame located over a build platform that is essentially a powder bed system, similar to the ones of regular powder bed printers. Control electronics may be responsible for controlling the motion of the laser diode platform (both horizontally and vertically), the laser activation sequencing, the powder bed elevation, the powder bed heaters, and the kinematics of the re-coater.

An exemplary control electronics board may include stepper motor controllers. Limit switches may be present on each of the stepper activated axes to enable homing of the build platform. Thermistors may be used to sense the temperature of the powder bed, while an IR sensor may be used to sense the temperature of the powder bed surface.

Two heating mechanisms may be provided: one that controls the temperature of the powder bed (e.g., through appropriate cartridge heaters) and one that controls the surface temperature of the powder (e.g., through a heat emitting lamp). The powder bed heater(s) may be attached inside the walls of the powder bed and the build platform, while the surface heater may be mounted over the powder. The lamp may be powered during the recoating phase to provide additional means of keeping the top powder layer temperature at desired levels.

The system may be controlled by an appropriate controller such as, for example, an Arduino DUE microcontroller that is responsible for communicating with the stepper controllers through an I2C interface. Controlling the laser on/off state may be achieved through dedicated high-power MOSFET transistors and by controlling the transistor gate.

The micro-controller may communicate with a personal computer through a regular USB interface operating at serial mode.

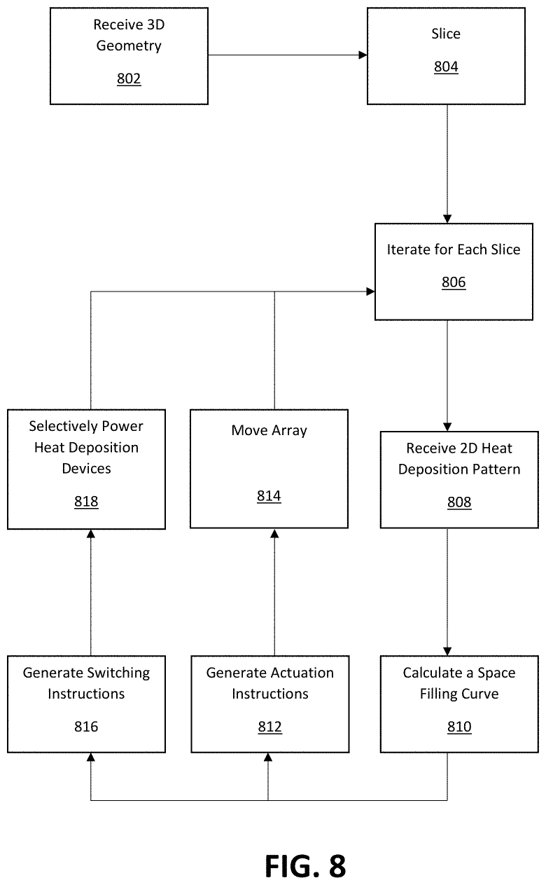

The micro-controller and/or personal computer may run an exemplary process 800 illustrated in FIG. 8. At block 802, a 3D geometry is received. At block 804 the 3D geometry is sliced, using any appropriate method known in the art, into a series of stacked 2D planes (heat deposition patterns) collectively approximating the 3D geometry. At block 806, the process iterates future steps for each slice. At block 808, a desired 2D heat deposition pattern is received. At block 810, a space filling curve for an area under the array of heat deposition devices is calculated, based on the received pattern and a known 2-dimensional array of heat deposition elements. At block 812, actuation instructions based on the space filling curve are generated. At block 814 the array of heat deposition devices are moved, based on the actuation instructions, thereby following the space filling curve. At block 816, switching instructions are generated, based on the received pattern and the space filling curve, for the heat deposition devices. At block 818, the heat deposition devices are selectively powered while the array is moving, based on the switching instructions, thereby depositing energy that matches the desired 2D heat deposition pattern when the array follows the space filling curve.

Exemplary embodiments of the present invention exhibit the following advantages and new features when compared to conventional additive manufacturing methods and apparatuses.

1. Exemplary systems includes an array of energy deposition devices attached to a planar motion platform and doesn't need delicate optics to operate.

2. The parallelization of the energy deposition provided by the energy deposition array, allows for very high print rates that scale very favorably compared to point by point approaches. It is estimated that for the same cost of equipment the proposed approach can be more than twenty times faster as point by point systems.

3. Exemplary systems can accommodate a number of energy deposition devices that might transfer energy in the forms of: electron, laser, or microwave beams.

4. Exemplary systems can be scaled up to accommodate very large print areas in contrast to conventional laser systems that are restricted by optical aberration effects.

5. Scaling up exemplary systems is a trivial repetition of the same design and does not require any fundamental modifications.

6. Exemplary systems operate on the principle of a repeating space-filling motion. The melting of the material may be performed solely by controlling the time characteristics of each individual element of the energy deposition array. This is in contrast with traditional systems that both the motion and the activation sequencing need to be controlled.

7. Exemplary system control is simplified because the motion is always predetermined through a single build and only the individual element time activation characteristics need to be controlled.

8. The energy is deposited in a more distributed manner than traditional additive manufacturing hence providing a more uniform heating profile and avoids local thermal shocking.

9. Because of the distributed architecture and the powder preheating strategy exemplary systems can be manufactured using inexpensive and low power laser diodes. This is in contrast to traditional additive manufacturing systems that require expensive lasers and very precise optics engineering.

10. The use of low power lasers enables miniaturization of the embodiment since traditionally large sub-systems like cooling are not required.

11. Exemplary systems can be either for inexpensive polymer type material additive manufacturing or for more demanding metal based additive manufacturing, while still adopting the same platform, control electronics and software.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. An additive manufacturing device comprising:
a container bed configured to contain material powder;
a printing bed over which material is deposited and heat applied;
one or more heating elements configured to hold material on the printing bed and material on the container bed at temperatures higher than ambient;
one or more actuators; and
a two-dimensional array of heat deposition devices configured for movement by the one or more actuators in a plane generally perpendicular to a beaming axis of the heat deposition devices.

2. The additive manufacturing device of claim 1, further comprising a re-coater blade configured to actuate so as to transfer powder from the container bed to the printing bed.

3. The additive manufacturing device of claim 1, wherein the powder container is configured to actuate in the vertical direction an amount correlated to a desired thickness of a powder layer to be transferred to the printing bed.

4. The additive manufacturing device of claim 1, wherein the printing bed is configured to actuate in the vertical direction, after each layer has been built, making room for a new layer of material powder.

5. The additive manufacturing device of claim 1, wherein the one or more actuators include a first actuator configured to move the array in a first direction perpendicular to the beaming axis and a second actuator configured to move the array in a second direction, the second direction being perpendicular to the beaming axis and perpendicular to the first direction, and
wherein the two-dimensional array of heat deposition devices is configured for movement in the first and second directions simultaneously.

6. The additive manufacturing device of claim 1, further comprising:
a processor, the processor configured to perform the steps of:
receiving a desired 2D heat deposition pattern;
calculating, based on the received pattern and a known 2-dimensional array of heat deposition elements, a space filling curve for an area under the array of heat deposition devices;
generating actuation instructions based on the space filling curve;
moving the array of heat depositions devices based on the actuation instructions, thereby following the space filling curve;
generating switching instructions, based on the received pattern and the space filling curve, for the heat deposition devices; and
selectively powering the heat deposition devices while the array is moving, based on the switching instructions, thereby depositing energy that matches the desired 2D heat deposition pattern when the array follows the space filling curve.

7. A method of additive manufacturing comprising:
coating a printing bed by moving a re-coater plate through material in a powder container;
moving the powder container vertically upwards for each layer;
moving the printing bed vertically downwards for each layer;
moving a two-dimensional array of heat deposition devices horizontally within predefined limits;
selectively switching on and off the heat deposition devices during movement of the two-dimensional array; and
providing power to heating elements configured to heat material on the printing bed and the powder container.

8. The method of claim 7, wherein the steps of the method are selectively completed based on an object to be printed by the method.

9. A method of additive manufacturing comprising:
receiving a desired 2D heat deposition pattern;
calculating, based on the received pattern and a known 2-dimensional array of heat deposition devices, a space filling curve for an area under the array of heat deposition devices;
generating actuation instructions based on the space filling curve;
moving the array of heat deposition devices based on the actuation instructions, thereby following the space filling curve;
generating switching instructions, based on the received pattern and the space filling curve, for the heat deposition devices; and
selectively powering the heat deposition devices while the array is moving, based on the switching instructions, thereby depositing energy that matches the desired 2D heat deposition pattern when the array follows the space filling curve.

10. The method of claim 9, further comprising the steps of:
receiving a 3D geometry;
slicing the 3D geometry into a series of stacked 2D heat deposition patterns collectively approximating the 3D geometry; and
iteratively performing the steps of receiving, calculating, generating actuation instructions, moving, generating switching instructions, and selectively powering the heat deposition devices for each heat deposition pattern.
